(19) United States
(12) Patent Application Publication
(10) Pub. No.: US 2013/0327530 A1
(43) Pub. Date: Dec. 12, 2013

(54) Composition and Method to Replace Polysacharides in Hydraulic Fracturing

(71) Applicants: Sarkis Kakadjian, The Woodlands, TX (US); Frank Zamora, San Antonio, TX (US)

(72) Inventors: Sarkis Kakadjian, The Woodlands, TX (US); Frank Zamora, San Antonio, TX (US)

(73) Assignee: Trican Well Service Ltd, Calgary (CA)

(21) Appl. No.: 13/492,591

(22) Filed: Jun. 8, 2012

(51) Int. Cl. E21B 43/26; C09K 8/62

(52) U.S. Cl. 166/308.1; 507/240

(57) ABSTRACT

A method to reduce the amount of gelling agent utilized in hydraulic fracturing fluids in the presence of a relatively high concentration of brine.

### BACKGROUND

Hydraulic fracturing is a common and well-known enhancement method for stimulating the production of hydrocarbons and natural gas in particular. The process involves injecting fluid down a wellbore at high pressure. The fracturing fluid is typically a mixture of water, proppant, and chemicals to improve the process. The chemicals improve the fracturing process in many ways such as by allowing the water to carry sufficient proppant to the desired locations. Other chemicals such as friction reducers reduce the drag friction reducing the amount of power necessary to pump the fluid downhole. Additionally, chemicals are often added to the fluid to aid in wettability, pH control and bacterial control.

Generally the fracturing process includes pumping the fracturing fluid from the surface through a tubular. The tubular has been prepositioned in the wellbore to access the desired hydrocarbon formation. The tubular has been sealed both above and below the formation to isolate fluid flow either into or out of the desired formation and to prevent unwanted fluid loss. Pressure is then provided from the surface to the desired hydrocarbon formation in order to open a fissure or crack in the hydrocarbon formation.

One type of chemical that may be used to improve the fracturing process is a chemical to allow the water to carry the proppant without having the proppant settle out of the mixture. One of the most common chemicals to be used for this purpose is a guar or polysaccharide used as linear gel system. In the past it was not unusual to utilize 30 or 40 pounds of gelling agent per thousand gallons of water. Unfortunately, due to the greatly increased demand for gelling agent and currently limited supply the cost per pound of gelling agent has greatly increased.

A means of reducing the amount of gelling agent in a hydraulic fracturing fluid when freshwater is used as the main component of the hydraulic fracturing fluid is to reduce the total amount of gelling agent used. Typically a friction reducer was used to enhance the ability of the reduced amount of gelling agent to carry the proppant. In freshwater such a mixture could approach the performance of using gelling agent alone.

Large amounts of fluid, typically water, are required in a typical hydraulic fracturing operation. At the well site, the fluid is mixed with the appropriate chemicals and proppant particulates and then pumped down the wellbore and into the cracks or fissures in the hydrocarbon formation. A typical slick water hydraulic fracturing fluid could include a partially hydrolyzed polyacrylamide polymer as a friction reducer.

In many instances it may be preferable to use the produced water from the well as the main component of the fracturing fluid. Unfortunately, water produced from most hydrocarbon wells contain large quantities of dissolved solids, particularly the divalent cations such as sodium, calcium, and magnesium. When the concentration of the divalent cations exceed 50 parts per million the fluid is referred to as a brine solution. Produced brine solution reduces the effectiveness of current friction reducers to assist the gelling agent in transporting the proppant. In freshwater the friction reducer may increase the viscosity of the linear gel systems when using a reduced amount of gelling agent by as much as 90% where in a brine solution the same degree of substitution has a marginal effect on the viscosity of the linear gel system.

In the search for a means to reduce the amount of gelling agent it was found that, in fresh water, 50 percent of the gelling agent could be replaced by small amounts of particular friction reducers. In this instance the effectiveness of the proppant transport mechanism (the gelling agent) and the friction reducer could be maintained at levels roughly equivalent to using the full amount of the gelling agent.

Unfortunately when a brine solution is utilized as the main component of the fracturing fluid using the previous compositions alone to reduce the total amount of gelling agent is no longer possible.

### SUMMARY OF THE INVENTION

When a brine solution has been determined to be preferable to freshwater as a basis for the fracturing fluid a new solution utilizing a mixture of brine, a reduced amount of gelling agent, a friction reducer, and a particular quaternary salt may be used.

By utilizing the proper ratios of friction reducer to quaternary salt it is possible to reduce the total amount of gelling agent utilized without negatively affecting the ability of the fluid to transport proppant into the formation.

Generally, when in the presence of brine the gelling agent may be reduced by half by generally adding certain amounts of a friction reducer a quaternary salt. In the embodiments described below the brine has a divalent cation concentration in excess of 50 parts per million, where the most frequently utilized, but not only brine has a divalent cation concentration between 50 and 10,000 parts per million. The gelling agent used may be from 5 to 25 pounds per thousand gallons of water. The friction reducer used may be from 1 to 30 pounds per thousand gallons of water The quaternary salt used may be from 0.1 to 4.2 pounds per thousand gallons of water.

### BRIEF DESCRIPTION OF THE DRAWINGS

FIG. 1 is a graph that depicts the viscosity of a 20 pound gelling agent mixture compared to a 10 pound gelling agent mixture with various additives with respect to time.

FIG. 2 is a graph that depicts the viscosity of a 30 pound gelling agent mixture compared to a 15 pound gelling agent mixture with various additives with respect to time.

FIG. 3 is a graph that depicts the viscosity of a 20 pound gelling agent mixture compared to a 10 pound gelling agent mixture and 12.5 pounds of friction reducer with various amounts of a quaternary salt with respect to time.

### DETAILED DESCRIPTION

The description that follows includes exemplary apparatus, methods, techniques, or instruction sequences that embody techniques of the inventive subject matter. However, it is understood that the described embodiments may be practiced without these specific details.

In the tests referred to below the brine is an American Petroleum Institute standard brine that is 8.5% weight to volume sodium chloride and 2.5% weight to volume of calcium chloride.

Also in the tests below viscosity is tracked over time. The viscosity of the fluid is a typical measure of a fluids ability to transport proppant.

Typically, polyacrylamide and polyacrylate polymers and copolymers are used as friction reducers at low concentrations for all temperatures ranges.

Typical gelling agents include guar gums, hydroxypropyl guar, carboxymethyl hydroxypropyl guar, carboxymethyl guar, and carboxymethyl hydroxyethyl cellulose. Suitable hydratable polymers may also include synthetic polymers, such as polyvinyl alcohol, polyacrylamides, poly-2-amino-2-methyl propane sulfonic acid, and various other synthetic polymers and copolymers. Other examples of such polymers include, without limitation, guar gums, high-molecular weight polysaccharides composed of mannose and galactose sugars, or guar derivatives such as hydropropyl guar (HPG), carboxymethyl guar (CMG), carboxymethylhydropropyl guar (CMHPG), hydroxyethylcellulose (HEC), hydroxypropylcellulose (HPC), carboxymethylhydroxyethylcellulose (CMHEC), xanthan, and scleroglucan.

The preferred quaternary salt is Alkyl (C12-16) Dimethylbenzylammonium chloride. Typical quaternary salts may be described by the formula R¹R²R³ArN+X⁻, where R¹ and R² are carbyl groups including 1 to 3 carbon atoms, R³ is a carbyl group including about 8 to about 20 carbon atoms, Ar is an aryl group and X⁻ is a counterion, (2) compounds of the general formula R¹R²R³R⁴N+X⁻, where R¹ and R² are carbyl group including 1 to 3 carbon atoms, R³ and R⁴ are a carbyl group including about 6 to about 10 carbon atoms, and X⁻ is a counterion or (3) mixtures and combinations thereof, where X⁻ includes chloride (Cl⁻), bromide (Br⁻), hydroxide (OH⁻), or mixtures thereof.

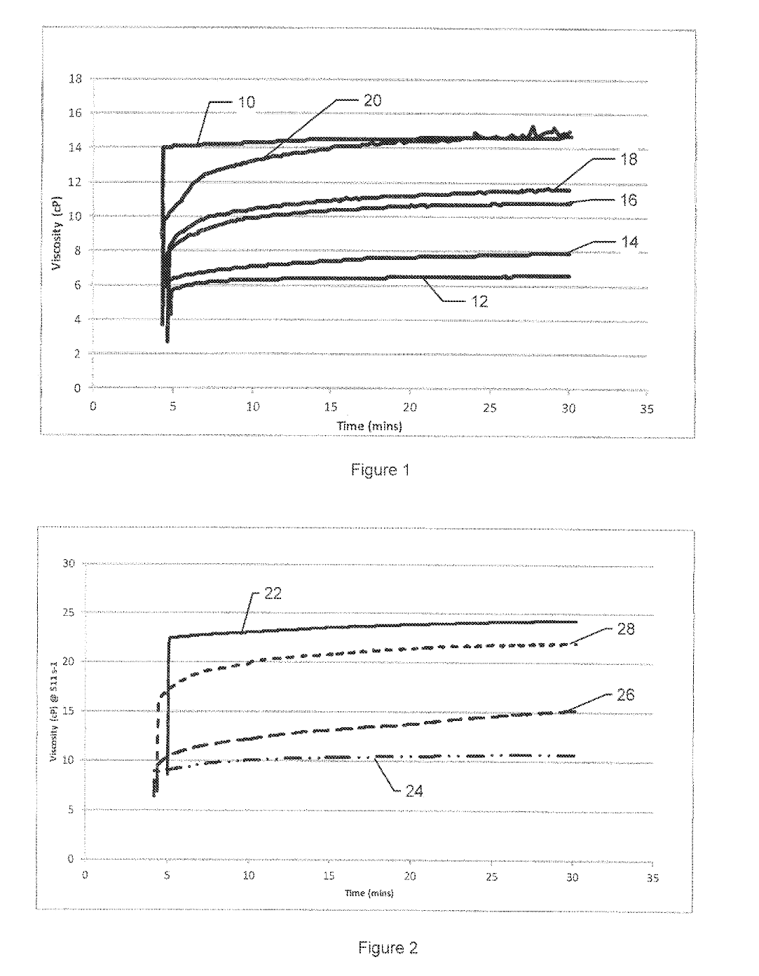

FIG. 1 is a graph that depicts the viscosity of various fracturing fluids with respect to time. Reference numeral 10 depicts a guar solution utilizing 20 pounds of gelling agent per 1000 gallons of brine. Reference numeral 12 depicts a gelling agent solution utilizing a reduced amount of gelling agent, 10 pounds of gelling agent per 1000 gallons of brine with an additional 8.75 pounds of a friction reducer per 1000 gallons of brine. As can be readily observed the viscosity falls off dramatically with the removal of 50% of the gelling agent while the addition of the friction reducer seemingly did little or nothing to prevent the radical drop-off in viscosity.

Reference numeral 14 depicts a gelling agent solution utilizing a reduced amount of gelling agent, 10 pounds of gelling agent per 1000 gallons of brine with 8.75 pounds of friction reducer per 1000 gallons of brine, and an additional 0.42 pounds of a quaternary salt per thousand gallons of water. The graph indicates that the addition of a small amount of quaternary salt slightly improves the viscosity of the gelling agent/friction reduction mixture despite the presence of the sodium chloride and calcium chloride.

Reference numeral 16 depicts a gelling agent solution utilizing a reduced amount of gelling agent, 10 pounds of gelling agent per 1000 gallons of brine, with 8.75 pounds of friction reducer per 1000 gallons of brine, and a slightly higher amount of quaternary salt, now 2.09 pounds of a quaternary salt per thousand gallons of water is added. With the additional quaternary salt the viscosity is again improved with respect to both the mixtures graphed as reference numeral 12 and 14.

Reference numeral 18 depicts a gelling agent solution utilizing a reduced amount of gelling agent, 10 pounds of gelling agent per 1000 gallons of brine, with 8.75 pounds of friction reducer per 1000 gallons of brine, and an even higher amount of quaternary salt, now 4.17 pounds of a quaternary salt per thousand gallons of water is added. With the additional quaternary salt the viscosity is again improved with respect to the mixtures graphed as reference numeral 12, 14, and 16.

Reference numeral 20 depicts a gelling agent solution utilizing a reduced amount of gelling agent, 10 pounds of gelling agent per 1000 gallons of brine. However, the amount of friction reducer is increased slightly to 12.5 pounds per 1000 gallons of brine and the amount of quaternary salt is reduced to 2.09 pounds per thousand gallons of water. In this case the quaternary salt is reduced to the same amount as used before and graphed as reference numeral 16 but the friction reducer is increased slightly. With the proper ratios of friction reducer and quaternary salt the viscosity performance of the mixture approximates that of the 100% gelling agent.

FIG. 2 is a graph that depicts the viscosity of various fracturing fluids with respect to time. In this case reference numeral 22 depicts a gelling agent solution utilizing 30 pounds of gelling agent per 1000 gallons of brine. However in this case each of the other mixtures utilize a reduction in the amount of gelling agent to 15 pounds per thousand gallons of water instead of a reduction to 10 pounds of gelling agent per thousand gallons of water as were graphed in FIG. 1. Reference numeral 24 depicts a gelling agent solution utilizing a reduced amount of gelling agent, 15 pounds of gelling agent per 1000 gallons of brine, with an additional 14.375 pounds of a friction reducer per 1000 gallons of brine. As can be readily observed, again the viscosity falls off dramatically with the removal of even 25% of the gelling agent while the addition of the friction reducer seemingly did little or nothing to prevent the radical drop-off in viscosity.

Reference numeral 26 depicts a gelling agent solution utilizing a reduced amount of gelling agent, 15 pounds of gelling agent per 1000 gallons of brine, with 14.375 pounds of friction reducer per 1000 gallons of brine, with 0.83 pounds of a quaternary salt per thousand gallons of water. With the additional quaternary salt the viscosity is only slightly improved with respect to the mixture graphed as reference numeral 24.

Reference numeral 28 depicts a gelling agent solution utilizing a reduced amount of gelling agent, 15 pounds of gelling agent per 1000 gallons of brine, with 14.375 pounds of friction reducer per 1000 gallons of brine, with 2.09 pounds of quaternary salt per thousand gallons of water. In this case, with the stated ratios of friction reducer and quaternary salt the viscosity performance of the mixture closes in on the performance of the 100% gelling agent but does not quite match it.

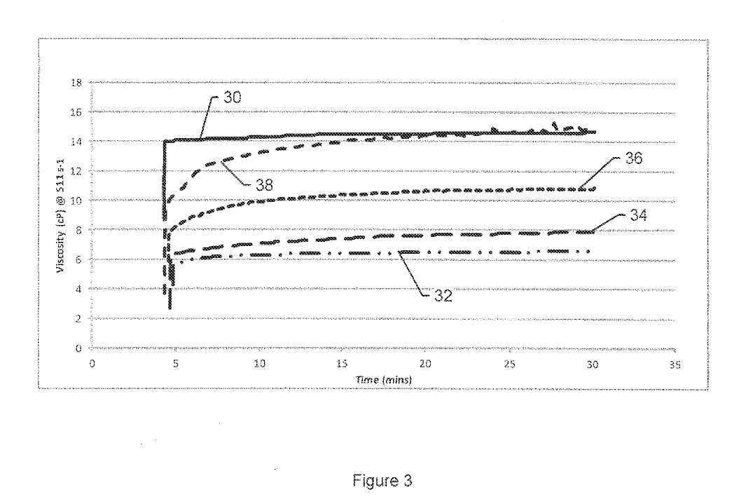

FIG. 3 is a graph that depicts the viscosity of various fracturing fluids with respect to time. In this case reference numeral 30 depicts a gelling agent solution utilizing 20 pounds of gelling agent per 1000 gallons of brine.

Reference numeral 32 depicts a gelling agent solution utilizing a reduced amount of gelling agent, 10 pounds of gelling agent per 1000 gallons of brine with an additional 12.5 pounds of a friction reducer per 1000 gallons of brine. As can be readily observed the viscosity falls off dramatically with the removal of 50% of the gelling agent while the addition of the friction reducer seemingly did little or nothing to prevent the radical drop-off in viscosity.

Reference numeral 34 depicts a gelling agent solution utilizing a reduced amount of gelling agent, 10 pounds of gelling agent per 1000 gallons of brine with 12.5 pounds of friction reducer per 1000 gallons of brine, and 0.42pounds of quaternary salt per thousand gallons of water. The graph indicates that the addition of a small amount of quaternary salt slightly improves the viscosity of the gelling agent/friction reduction mixture with respect to the mixture depicted by reference numeral 32, despite the presence of the sodium chloride and calcium chloride.

Reference numeral 36 depicts a gelling agent solution utilizing a reduced amount of gelling agent, 10 pounds of gelling agent per 1000 gallons of brine, with 12.5 pounds of friction reducer per 1000 gallons of brine, and a slightly higher amount of quaternary salt, now 0.83 pounds of quaternary salt per thousand gallons of water. With the additional quaternary salt the viscosity is again improved with respect to both the mixtures graphed as reference numeral 32 and 34.

Reference numeral 38 depicts a gelling agent solution utilizing a reduced amount of gelling agent, 10 pounds of gelling agent per 1000 gallons of brine, with 12.5 pounds of friction reducer per 1000 gallons of brine, and an even higher amount of quaternary salt, now 2.09 pounds of quaternary salt per thousand gallons of water. In this case, as in the case depicted by reference numeral 20 in FIG. 1, the proper ratios of friction reducer and quaternary salt have a viscosity performance that approximates that of the 100% gelling agent.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A composition for fracturing a well comprising:
a brine;
a gelling agent;
a friction reducer; and,
a quaternary salt.

2. The composition of claim 1 wherein the brine has a divalent cation concentration between 50 parts per million and 10,000 parts per million.

3. The composition of claim 2 wherein the divalent cation is calcium.

4. The composition of claim 2 wherein the divalent cation is magnesium.

5. The composition of claim 1 wherein the brine has a divalent cation concentration in excess of 10,000 parts per million.

6. The composition of claim 5 wherein the divalent cation is calcium.

7. The composition of claim 5 wherein the divalent cation is magnesium.

8. The composition of claim 1 wherein the amount of gelling agent utilized in the composition is between 5.0 and 25.0 pounds per thousand gallons of brine.

9. The composition of claim 1 wherein the amount of gelling agent utilized in the composition is between 17.5 and 22.5 pounds per thousand gallons of brine.

10. The composition of claim 1 wherein the amount of gelling agent utilized in the composition is between 12.5 and 17.5 pounds per thousand gallons of brine.

11. The composition of claim 1 wherein the amount of gelling agent utilized in the composition is between 7.5 and 12.5 pounds per thousand gallons of brine.

12. The composition of claim 1 wherein the amount of friction reducer utilized in the composition is between 1.0 and 30.0 pounds per thousand gallons of brine.

13. The composition of claim 1 wherein the amount of friction reducer utilized in the composition is between 19.0 and 26.0 pounds per thousand gallons of brine.

14. The composition of claim 1 wherein the amount of friction reducer utilized in the composition is between 18.75 and 13.75 pounds per thousand gallons of brine.

15. The composition of claim 1 wherein the amount of friction reducer utilized in the composition is between 13.75 and 8.0 pounds per thousand gallons of brine.

16. The composition of claim 1 wherein the amount of quaternary salt utilized in the composition is between 0.42 and 4.17 pounds per thousand gallons of brine.

17. The composition of claim 16 wherein the quaternary salt is Alkyl (C12-16) Dimethylbenzylammonium chloride.

18. The composition of claim 1 wherein the amount of quaternary salt utilized in the composition is between 1.67 and 2.50 pounds per thousand gallons of brine.

19. The composition of claim 18 wherein the quaternary salt is Alkyl (C12-16) Dimethylbenzylammonium chloride.

20. A method of fracturing a well comprising:
preparing a hydraulic fracturing fluid comprising a brine, a gelling agent, and a proppant;
adding a friction reducer and a quaternary salt; and
introducing the combination of the brine, the gelling agent, the proppant, the friction reducer, and the quaternary salt into a well to fracture a formation.

21. The method of claim 20 wherein the brine has a divalent cation concentration between 50 parts per million and 10,000 parts per million.

22. The method of claim 21 wherein the divalent cation is calcium.

23. The method of claim 21 wherein the divalent cation is magnesium.

24. The method of claim 16 wherein the brine has a divalent cation concentration in excess of 10,000 parts per million.

25. The method of claim 24 wherein the divalent cation is calcium.

26. The method of claim 24 wherein the divalent cation is magnesium.

27. The method of claim 20 wherein the amount of gelling agent utilized in the composition is between 5.0 and 25.0 pounds per thousand gallons of brine.

28. The method of claim 20 wherein the amount of gelling agent utilized in the composition is between 17.5 and 22.5 pounds per thousand gallons of brine.

29. The method of claim 20 wherein the amount of gelling agent utilized in the composition is between 12.5 and 17.5 pounds per thousand gallons of brine.

30. The method of claim 20 wherein the amount of gelling agent utilized in the composition is between 7.5 and 12.5 pounds per thousand gallons of brine.

31. The method of claim 20 wherein the amount of friction reducer utilized in the composition is between 1.0 and 30.0 pounds per thousand gallons of brine.

32. The method of claim 20 wherein the amount of friction reducer utilized in the composition is between 19.0 and 26.0 pounds per thousand gallons of brine.

33. The method of claim 20 wherein the amount of friction reducer utilized in the composition is between 18.75 and 13.75 pounds per thousand gallons of brine.

34. The method of claim 20 wherein the amount of friction reducer utilized in the composition is between 13.75 and 8.0 pounds per thousand gallons of brine.

35. The method of claim 20 wherein the amount of quaternary salt utilized in the composition is between 0.42 and 4.17 pounds per thousand gallons of brine.

36. The composition of claim 35 wherein the quaternary salt is Alkyl (C12-16) Dimethylbenzylammonium chloride.

37. The method of claim 20 wherein the amount of quaternary salt utilized in the composition is between 1.67 and 2.50 pounds per thousand gallons of brine.

38. The composition of claim 37 wherein the quaternary salt is Alkyl (C12-16) Dimethylbenzylammonium chloride.
